(19) United States
(12) Patent Application Publication
(10) Pub. No.: US 2007/0195732 A1
(43) Pub. Date: Aug. 23, 2007

(54) Method for releasing allocated resources at sip handover

(76) Inventors: Ammad Akram, Berkshire (GB); Nikolaos Prelorentzos, Athens (GB)

Correspondence Address: RATNERPRESTIA, P.O. BOX 980, VALLEY FORGE, PA, 19482, US

(21) Appl. No.: 10/571,973

(22) PCT Filed: Sep. 13, 2004
(86) PCT No.: PCT/GB04/03883

§ 371 Date: Jan. 8, 2007

(30) Foreign Application Priority Data
Sep. 15, 2003 (GB) 0321596.9

(51) Int. Cl. H04Q 7/00; H04L 12/56

(52) U.S. Cl. 370/331; 370/401

(57) ABSTRACT

When mobile communication is handed over from a first link to a second like, in order to relinquish resources as soon as possible, the release of resources allocated to the first link is initiated in response to the generation of the ACK signal by the mobile node, rather than waiting for a refresh command to time out.

This invention relates to mobile communications and in particular it relates to the release of network resources after handover that has been completed using the Session Initiation Protocol (SIP).

### INTRODUCTION

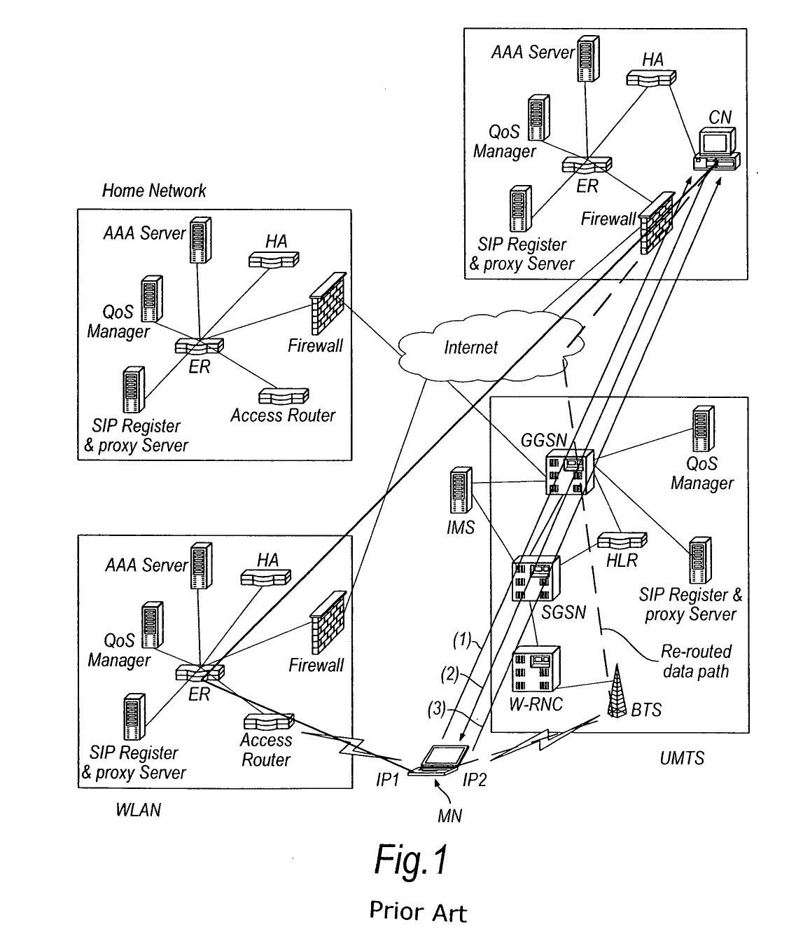

With reference to FIG. 1, a dual mode WLAN (Wireless Local Area Network)—UMTS (Universal Mobile Telecommunications System) mobile node (MN) wireless terminal has IP (Internet Protocol) connectivity with both WLAN and UMTS networks. IP connectivity to a network implies that a particular physical interface on the terminal is associated with an IP address derived from the prefix being used by the network. An IP address can be acquired through auto-configuration or with the assistance of a network element such as a DHCP (Dynamic Host Configuration Protocol). In the figure, IP1 and IP2 indicate the IP addresses used to reach the MN via the WLAN and UMTS networks respectively.

Using the SIP (Session Initiation Protocol, International Engineering Task Force RFC 3261) signalling protocol, a media path indicated by the solid line has been established between a corresponding node (CN) in the caller's network and the MN wireless terminal via the Internet and WLAN networks. The media path can, for example, be used to transport data packets related to Internet telephone calls (VoIP), multimedia distribution and multimedia conferences. Initially, the final leg of this media path is through the WLAN network.

Owing to reasons of mobility or some other reason, the quality of the established media path from CN to MN through the WLAN could begin to deteriorate as the MN moves away from the WLAN network. One possible metric used by the MN to detect decreasing channel quality could be layer 2 (L2) signal strength. Under these circumstances, it could be advantageous for the MN to attempt handover from the WLAN to an alternative available network in order to maintain the media path between CN and MN. The alternative network shown in FIG. 1 is the UMTS network. It is also possible the MN itself could initiate the handover in response to knowledge or events such as the alternative network offering a lower call charge during a certain period in the day etc.

The default Quality of Service (QoS) afforded to a general communications link operating in accordance with the Internet Protocol (IP) is termed Best Effort where network elements forward IP packets on a first come first served basis without any preference. For real time applications such as SIP facilitated VoIP, a certain amount network bandwidth has to be reserved, typically at traffic aggregation points such as the WLAN and caller's network edge routers (ER) shown in FIG. 1, to ensure that VoIP associated IP packets can be forwarded with delay and jitter (inter-packet delay) necessary to maintain a satisfactory VoIP connection. Further details on establishing QoS for IP telephony may be accessed via US 2002041590 and WO 02/078289.

The limited ER bandwidth set aside for real time services within the WLAN network is under the control of the WLAN QoS manager that determines whether to admit/reject a new user attempting to negotiate WLAN service through the SIP configuration process (RFC 3312). The admission and packet forwarding policy formulated by the QoS manager for a user is then enforced by the ER.

One task of the QoS manager is to control the allocation of the limited ER real time bandwidth to ensure that existent WLAN users do not experience degraded QoS as additional users join the WLAN network.

Additionally, the QoS manager has to release allocated WLAN network resources once a VoIP call comes to an end or if the MN moves from the WLAN network to a new network during an ongoing VoIP call. US 2002041590 addresses the former case where resources are released upon termination of the call as signalled by the SIP BYE message. The present invention addresses the situation where the MN moving to a new network rather than simply terminating the call in the current network triggers release of resources. In this handover scenario, no SIP BYE message is generated as the call is to be continued on the new network, again with QoS negotiated as outlined in RFC 3312. After the completion of the handover procedure, a timely release of the WLAN resources allocated to the MN is required to ensure optimum use of the limited WLAN network resources.

It is usual to associate reserved resources on a network with a predetermined timeout period during which time some type of refresh command is required to continue using these resources. Unless refreshed, the resources will be released upon expiry of the timeout period. The present invention seeks to synchronise the release of reserved resources with the handover process rather than simply wait for the timeout period to elapse. This leads to better utilisation of scarce network resources.

Examples of synchronising the handover process with release of resources can be found in the prior art, particularly WO03/021977 and EP1331832, but the context of these references can be differentiated from the present invention. WO03/021977 considers the handover of a single mode airborne MN between two satellite coverage areas. Upon completion of the handover, the MN signals to the ground station falling within the coverage of a second area at which point the second ground station signals to the first ground station to relinquish the communications channel with the MN. Aside from the different context of a single mode MN changing base stations within a homogeneous satellite communication system, there is no suggestion of the involvement of SIP protocol messages triggering other IP QoS release messages.

EP1331832 may appear to be similar to the present invention in that it also considers the handover of a dual mode terminal, in this case that of a GSM-UMTS dual mode MN from a GSM network to a UMTS network. Upon completion of handover to the UMTS network, the MN issues a GSM specific message that only releases resources on the GSM radio interface. However, in the present invention, it is the role of the CN or other communicating peer rather than the MN, upon receipt of specific SIP messages from the MN indicating that handover has been completed, to send IP specific QoS messages to release resources on network elements such as edge routers in the previous network rather than over the radio interface. Thus it will be seen that the present invention addresses the release of resources along the network path between CN & MN whereas WO03/021977 and EP1331832 are concerned with the release of radio interface resources negotiated between the MN and a base station.

An example of the invention will now be described with reference to the accompanying drawings in which like parts are designated like reference numerals and in which;

FIG. 1 schematically illustrates, first and second communication links between a mobile node and a corresponding node.

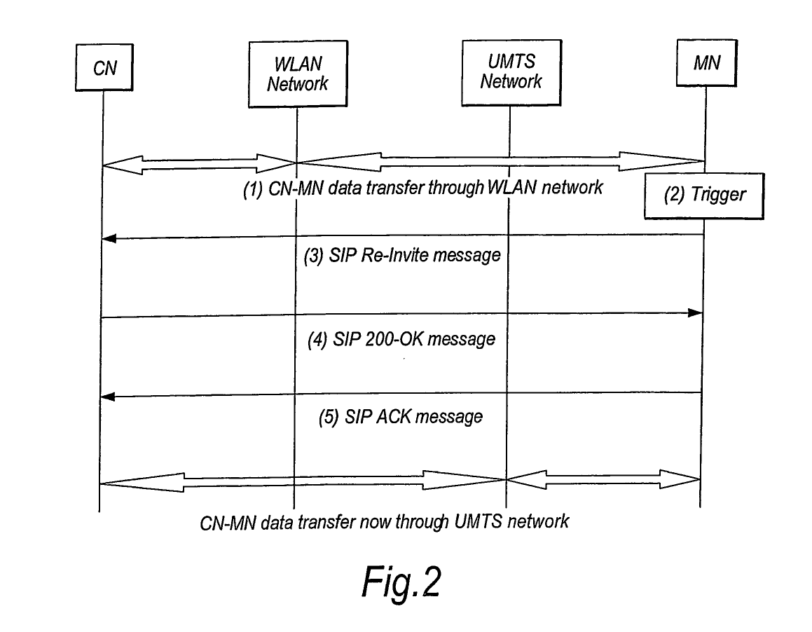

FIG. 2 illustrates steps 1 to 5 of the signal flow diagram required to complete handover and reroute data between the two communication links.

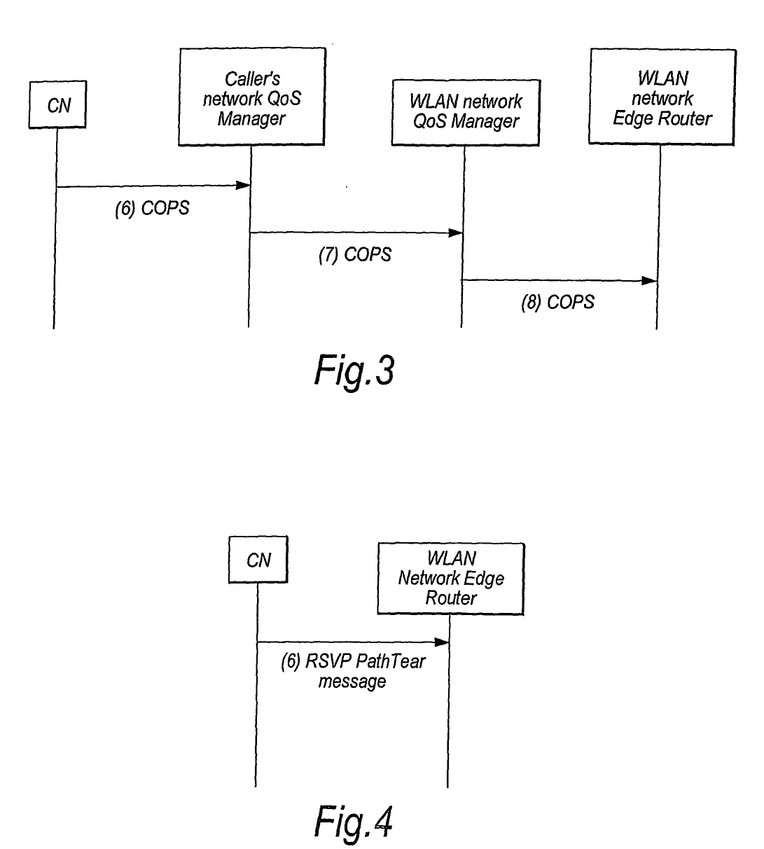

FIG. 3 illustrates steps 6 to 8 of the signal flow diagram for the CN to trigger release of WLAN resources following receipt of the ACK signal from the MN using the COPS protocol.

FIG. 4 illustrates step 6 of the signal flow diagram for the CN to trigger release of WLAN resources following receipt of the ACK signal from the MN using the RSVP protocol.

The process of handing over the MN from WLAN to UMTS occurs in a number of distinct steps whose timing is shown in FIG. 2. Each step is now described in detail.

Step 1—data packets are initially being transferred between CN and MN through the WLAN network

Step 2—a trigger is received or generated by the MN in response to events such as deteriorating WLAN channel quality or lower call tariff on alternative available network for example that necessitates a handover from current to new alternative network.

Step 3—in response to the trigger, the MN sends a SIP re-invite message to the CN through the new UMTS network. As the MN already knows the IP address of the CN, all SIP messages between MN and CN can go directly but the protocol does allow such messages to be routed via the UMTS SIP Register and proxy Server. The Re-invite message allows the MN and CN to re-negotiate details of the ongoing SIP session. The most relevant parameter to the current invention is the IP address of the MN's UMTS interface that is to be used by the CN to direct data packets after handover completion.

Step 4—the CN transmits a SIP 200-OK message to the MN agreeing to the change of IP address.

Step 5—for call reliability purposes, the MN transmits a SIP ACK message to the CN to conclude the SIP re-negotiation process. The arrival of the ACK at the CN is the trigger for CN to start using the new UMTS network related IP address to reach the MN.

This completes the handover and data re-routing steps. The process of triggering the release of WLAN resources after the arrival of the ACK signal at the CN occurs in a number of distinct steps whose timing is shown in FIG. 3. Each step is now described in detail.

Step 6—with the arrival of the ACK, the CN signals the QoS manager in its own network using the Common Open Policy Service (COPS) protocol [RFC 2748]. COPS is a simple query and response protocol that can be used to exchange information between a policy server (Policy Decision Point or PDP) and its clients (Policy Enforcement Points or PEPs). A policy is a combination of rules and services that define the criteria for resource access and usage. In COPS the PEP sends requests, updates, and deletions to the PDP and the PDP returns decisions back to the PEP. The basic message formats for COPS include Requests (REQs), Decisions (DECs), and Report States (RPTs), among many others. In the context of this invention, the CN with assistance from the QoS managers can be viewed as the PDPs with the WLAN router as the PEP.

Step 7—on receipt of the COPS signal from the CN, the QoS manager serving the CN in the caller's network signals (using COPS) to the WLAN QoS manager to clear the resources allocated for the MN.

Step 8—the WLAN QoS manager further passes on this COPS resource release request to the WLAN router that then actually releases the resources previously allocated for the MN.

In an alternative scenario where WLAN resources have been allocated using the RSVP protocol [RFC 2205], steps 6 to 8 can be replaced with the CN initiating RSVP PathTear resources release messages upon receipt of the ACK (FIG. 4). In this case, there is no reliance on COPS signalling that may have to be extended to support communication between (i) CN and the caller's network QoS manager and (ii) caller's network QoS manager and the WLAN network QoS manager. It should be noted that perhaps the enhanced RSVP protocol currently being developed within the IETF is a more appropriate protocol for releasing WLAN resources in FIG. 4. The standard RSVP protocol is not particularly well suited in cases where mobility is involved. It is possible that RSVP PathTear messages shown in FIG. 4 could also trigger release of any resources that may have been reserved within the caller's network. The enhanced RSVP protocol is being developed to modify resource allocation within specific segments of the end-to-end data path.

1. A method of relinquishing resources allocated to a first communications link between a mobile node (MN) and a corresponding node (CN), following SIP handover to a second communications link between the mobile node and the corresponding node, the first link routing signals via a first network and the second link routing signals via a second network, the method comprising the steps of:
receiving an ACK message, from the MN;
in response to the ACK message, sending a signal to initiate the release of resources allocated to the first communications link; and
relinquishing the resources allocated to the first communication link in response to the signal to initiate the release of the resources.

2. A method as claimed in claim 1 wherein the signal to initiate the release of resources is triggered by reception of the ACK message at the CN.

3. A method as claimed in claim 1 wherein the second network includes a SIP Proxy Server and the signal to initiate the release of resources is triggered by reception of the ACK message at the SIP Proxy Server of the second network.

4. A method as claimed in claim 1, 2 or 3 wherein the first network includes a quality of service (QoS) manager and the signal to initiate the release of resources is relayed from the CN to the QoS manager of the first network.

5. A method as claimed in claim 3 wherein the signal to the QoS manager of the first network is relayed by a network QoS manager of the second network.

6. A method as claimed in claim 5 wherein the signal from the network QoS manager of the second network to the QoS manager of the first network is relayed using a common open policy service COPS protocol.

7. A method as claimed in claim 1, 2 or 3 in which the signal to initiate the release of resources is relayed to a traffic aggregation point of the first network.

8. A method as claimed in claim 7 in which the traffic aggregation point is an edge router of the first network.

9. A method as claimed in claim 7 in which the signal to initiate the release of resources is relayed using Resource ReSerVation Protocol (RSVP) protocol.

10. (canceled)

11. A method as claimed in claim 8 in which the signal to initiate the release of resources is relayed using Resource ReSerVation Protocol (RSVP) protocol.
